(19) United States
(12) Patent Application Publication
(10) Pub. No.: US 2026/0216625 A1
(43) Pub. Date: Jul. 30, 2026

(54) FLUID DRAIN SYSTEM FOR FILTER CHAMBER ACCESS IN HEAT REJECTION UNIT

(71) Applicant: Microsoft Technology Licensing, LLC, Redmond, WA (US)

(72) Inventors: Yimin ZHANG, Johns Creek, GA (US); Xianfa ZHANG, Sammamish, WA (US); Brandyn David GIROUX, Bothell, WA (US); Joel Kevin JOSEPH, Mill Creek, WA (US); Andrew Douglas DELANO, Woodinville, WA (US); Chang Chi LIN, Taipei (TW); Nehal MODY, Redmond, WA (US); John Jason BRZOZOWSKI, Schwenksville, PA (US); Nisha Susan JOHN, Bothell, WA (US); Siddharth BHOPTE, Sammamish, WA (US); Guixiang Ellen TAN, Portland, OR (US); Wen Pin HUANG, Taipei (TW); Christian AMOAH-KUSI, Portland, OR (US); Chin-Han CHAN, Taipei City (TW); Tsunglin LIU, Taipei City (TW); Yen Lu CHENG, Changhua City (TW)

(21) Appl. No.: 19/041,239

(22) Filed: Jan. 30, 2025

(51) Int. Cl. B01D 35/12; F28F 19/01

(52) U.S. Cl. CPC B01D 35/12; F28F 19/01; F28F 2265/18; F28F 2265/22

(57) ABSTRACT

A method for servicing a component within a filter chamber assembly of a liquid-to-air Heat Rejection Unit (HRU) includes mating a receptacle on a fluid containment apparatus with a drain valve component on a filter chamber assembly to open a seal between the drain valve component and the filter chamber assembly. While the receptacle is mated to the drain valve component, a plunger of the fluid containment apparatus is actuated to draw coolant from the filter chamber assembly into a vial of the fluid containment apparatus. While the coolant from the filter chamber assembly is contained within the vial, the component within the filter chamber assembly is serviced and, following servicing, the plunger of the fluid containment apparatus is actuated toward the vial to reinject the coolant into the filter chamber assembly.

### BACKGROUND

Modern computing systems, including systems for providing artificial intelligence (AI) solutions, process large numbers of transactions and, therefore, consume high levels of power. As a result, such systems also generate excessive heat levels. With the increased chip power consumption and heat generation for such new AI platforms, traditional air-cooled server rack design cannot meet the cooling needs of new AI and cloud platforms. For this reason, many data center providers are striving to implement liquid-to-air cooling technologies at facilities not equipped with liquid cooling reservoirs. There exist many challenges with implementing liquid-to-air cooling technology, as this is an immature technology and is not commonly used at large scale.

### SUMMARY

The disclosed technology provides methods for draining liquid coolant from a filter chamber of a liquid-to-air heat rejection unit as a routine part of a filter chamber service operation. The coolant is drained using a fluid containment apparatus. The method provides for mating a receptacle on a fluid containment apparatus to a drain valve component on the filter chamber assembly to open a seal between the drain valve component and an interior of the filter chamber assembly. While the receptacle is mated to the drain valve component, a plunger is actuated to draw coolant from the filter chamber into a vial of the fluid containment apparatus. While the coolant from the filter chamber is contained within the vial, a technician services the component with the filter chamber assembly, and, subsequent to servicing, the plunger of the fluid containment apparatus is actuated toward the vial to reinject the coolant into the filter chamber assembly through the receptacle.

The above presents a simplified summary of the innovation in order to provide a basic understanding of some implementations described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

Other implementations are also described and recited herein.

### BRIEF DESCRIPTIONS OF THE DRAWINGS

FIG. 1 illustrates an example cooling system implementing aspects of the disclosed technology that improve the serviceability of HRU filter chambers.

FIG. 2 illustrates components of an example filter chamber service kit that is used to drain coolant from an HRU filter chamber assembly during a filter chamber access operation.

FIG. 3A illustrates steps performed during a filter chamber service operation using the disclosed technology.

FIG. 3B illustrates additional steps performed during the filter chamber service operation described with respect to FIG. 3A.

FIG. 3C illustrates still additional steps performed during the filter chamber service operation described with respect to 3A and 3B.

FIG. 4 illustrates example operations for servicing a component within a filter chamber assembly of a liquid-to-air HRU.

### DETAILED DESCRIPTION

Although liquid cooling technology is in high demand to support the high cooling needs of hardware used to perform artificial intelligence (AI) computations, data centers have been traditionally air-cooled. Consequently, few data centers are equipped with liquid cooling reservoirs. To address growing demands, liquid-to-air heat rejection units (HRUs) are being integrated into many modern cooling systems. A liquid-to-air HRU is a type of heat exchanger system that uses one or more fans to pull cold air in from a surrounding environment, such as from the output of a facility's air conditioning system. The liquid-to-air HRU includes a series of coils, tubes, or plates that contain a flow of liquid coolant. These coils, tubes, or plates contact the cold air brought in by the fan(s) and conductively transfer heat from the liquid coolant to the air, warming an airstream that is provided back to an intake of the room's air conditioning system.

In a typical HRU-driven cooling system, liquid coolant does not need to be circulated into a large, temperature-controlled (chilled) data center reservoir. Rather, one or more HRUs are positioned along the coolant loop to remove heat from the liquid coolant via transfer to air. In addition to the heat-exchange components described above, each HRU typically includes one or more internal channels that direct the liquid coolant through a filter, either before or after the coolant is directed through the heat-exchanging components. The purpose of the filter is to remove unwanted particles from the coolant, such as dirt, dust, and sediment, that is incidentally introduced into the coolant loop. The filter is included in a filter chamber of the HRU that is in line with the coolant flow. Accessing the filter typically entails closing one or more valves to isolate the filter chamber from the remainder of the coolant loop and then removing a cover from the filter chamber to acquire access to the filter. However, when the cover of the filter chamber is initially opened, the filter chamber is still filled with coolant, and the filter is fully immersed in the liquid coolant. When a service technician removes the filter or accesses other components in the filter chamber, it is common to spill coolant out of the chamber. This spilled coolant may seep into other areas of the HRU, including areas that house leak sensors.

If the coolant drips onto one of these liquid sensors, a leak detection alarm is triggered, and the HRU is commonly powered off, along with the IT rack it is cooling, to prevent damage. It is, therefore, an inconvenient and common incident for a technician to accidentally trigger the leak detection system of an HRU when changing an HRU filter. In IT systems management, it is undesirable for IT racks to remain powered off for any amount of time, as this disrupts customer data access operations. Additionally, the accidental tripping of HRU leak detection systems increases the labor burden on system technicians, who are then required to perform tedious operations to restore power to the HRUs and IT racks to return the powered-off hardware to a nominal operative state.

In some data centers, technicians utilize make-shift tools to assist with draining liquid coolant from the filter chamber in a way that does not cause coolant to spill within the HRU. For instance, a large bucket may be wheeled down the aisle between racks at the data center, and tubing may be used to redirect coolant within the filter chamber to the bucket. However, this methodology is onerous and time-consuming. Moreover, even in these scenarios where data center technicians can successfully drain the filter chamber fluid into the bucket, there is no convenient way of restoring the drained fluid to the coolant loop once the servicing operation is complete. Therefore, a quantity of coolant is lost from the coolant loop each time the filter chamber is accessed for servicing. After multiple service operations (e.g., three or more), this incidental coolant loss is significant enough to cause the HRU to malfunction, which typically trips an alarm to signal to the technician that the coolant level is too low to operate. This creates excess work for technicians who have to respond to such alarms by replenishing coolant. Additionally, replacing lost coolant with new coolant increases the operational costs of the data center.

The herein disclosed technology includes a filter servicing methodology and filter chamber service kit that a data center technician can use to easily drain the filter chamber of an HRU to facilitate filter chamber access for a servicing operation, such as for changing the HRU filter or other components (e.g., sensors) that reside in the filter chamber. The filter chamber service kit includes a syringe assembly with a receptacle that couples to a portion of a drain valve included within a wall of the filter chamber. The valve receptacle is coupled, via a hose, to a vial of a syringe that has an interior volume equal to or greater than the internal volume of the filter chamber. To drain coolant from the filter chamber into the syringe vial, a service technician mates the receptacle on the syringe assembly with the drain valve plug on the filter chamber and pulls the plunger on the syringe away from the vial. After the coolant has been drawn into and is contained within the syringe vial, the technician removes the filter chamber cover and thereby acquires access to the filter chamber that is now free of liquid coolant, allowing its components to be serviced without risk of spill. For example, a filter or flow meter within the filter chamber can be replaced. Following this servicing, the filter chamber cover is replaced, and the technician restores the displaced fluid into the filter chamber by depressing the actuator of the syringe into the vial, forcing the displaced coolant to flow back to its original location. Advantageously, this allows the filter chamber to be serviced without spilling or losing coolant from the HRU.

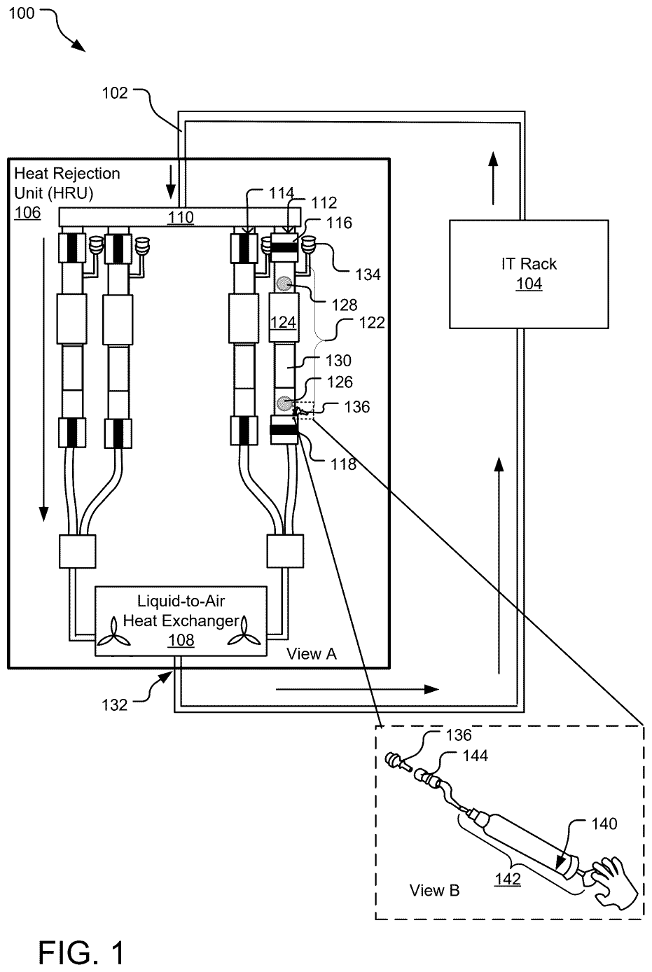

FIG. 1 illustrates an example cooling system 100 implementing the disclosed technology to improve the serviceability of HRU filter chambers. The cooling system 100 includes a liquid coolant loop 102 that circulates a flow of liquid coolant through an IT rack 104 that houses heat-generating components, such as central processing units (CPUs), graphics processing units (GPUs), hardware accelerators (e.g., field-programmable gate arrays (FPGAs)), and other hardware. Coolant delivered to the IT rack 104 is temperature-controlled by a heat rejection unit (HRU) 106, which includes a liquid-to-air heat exchanger 108. Upon entering the HRU 106, the liquid coolant is directed through a manifold 110 that splits the coolant into multiple streams and directs the streams through multiple channels (e.g., channels 112, 114) arranged in a parallel configuration. Below, aspects of each of these channels are generally described with respect to the channel 112, which may have components similar or identical to the other channels shown.

The channel 112 includes a pair of isolation valves 116, 118, arranged at the top (inlet) and bottom (outlet) of the channel 112, respectively. The isolation valves 116 and 118 sit on opposite sides of a filter chamber assembly 122. The filter chamber assembly 122 includes housing with a removable cover (not shown). The housing encases a cavity, which is accessed by removing the cover. This cavity is commonly referred to as the filter chamber because it encases a filter 124. Notably, the term “filter chamber assembly 122” refers to a collection of components, including those commonly referred to as the “filter chamber” (e.g., the filter chamber house, including its cover and the cavity within the filter chamber) in addition to all components accessible within the cavity including, for example, the filter 124 and various sensors (e.g., a flow meter 130 and pressure sensors 126, 128).

The cavity is in line with the flow of coolant through the channel. Thus, during nominal operations of the HRU 106, coolant flows through the cavity of the filter chamber assembly 122 and then through the liquid-to-air heat exchanger 108 before being recombined with coolant passing through the other channels of the HRU that are output at outlet 132, as a cooled stream of target temperature that flows according to a target flow rate and/or to maintain a target temperature differential across the HRU 106.

The cavity of the filter chamber assembly 122 includes at least a filter 124, an air-release valve 134, and a drain valve 136. The filter 124 functions to filter dirt and other particles from the liquid coolant during nominal cooling system operations. The air-release valve 134 and the drain valve 136 function to facilitate service operations that require access to the filter chamber assembly. Specifically, the drain valve 136 is used to drain coolant from the cavity of the filter chamber assembly 122 as a preliminary step in a filter chamber service operation. The air-release valve 134 functions to permit the controlled release of air from the cavity of the filter chamber assembly 122 as the cavity is being filled with coolant, such as upon completion of the filter chamber service operation, as is further discussed further below. The air-release valve 134 prevents the release of liquid coolant while it is expelling air.

As used herein, a filter chamber service operation refers to an operation that requires access to the cavity of the filter chamber assembly. For example, the filter chamber service operation is an operation that replaces the filter 124 or that repairs or replaces another component housed by the filter chamber assembly 122.

In various implementations, the filter chamber assembly 122 may house different types of components. In the implementation of FIG. 1, the cavity of the filter chamber assembly 122 includes a flow meter 130, which samples measurements of flow rate through the channel 112, as well as includes pressure sensors 126, 128 positioned on opposite sides of the filter 124 to facilitate measurement of a pressure drop within the filter chamber assembly 122. In some implementations, the HRU 106 includes a processing system that samples flow rate measurements from the flow meter 120 and pressure measurements from the pressure sensors 126, 128 to monitor for changed conditions tending to indicate that the filter 124 is dirty and negatively impacting the performance of the HRU 106. For example, a filter change notification is triggered when the pressures sensors 126 and 128 measure a pressure drop that exceeds a threshold. Likewise, the filter change notification may instead be triggered by a flow rate measurement indicating a flow rate drop through the HRU 106 that is of at least a threshold magnitude.

During a filter chamber service operation, a service technician first isolates the channel 112 (e.g., the channel that contains the filter chamber that is to be accessed) from the remainder of the liquid coolant loop 102 by closing the isolation valves 116, 118. At this point in time, the liquid coolant continues to flow through the other channels of the HRU 106 but both inlet and output of the channel 112 are sealed from the coolant loop 102.

In traditional HRUs that do not include the drain valve 136, the service technician would next remove the cover of the filter chamber assembly 122 to acquire access to the cavity and components therein. However, because the cavity is full of coolant, the cover removal can cause coolant to undesirably spill out into other areas of the HRU 106, which can trigger a leak alarm and commence automated actions (e.g., power down actions) of a leak detection system (not shown) that are designed to safe electrical equipment from damage.

According to the herein-disclosed improved service methodology, the operator drains the liquid coolant from the filter chamber assembly 122 prior to opening the cover of the filter chamber. This is achieved by coupling the drain valve 136 to a fluid containment apparatus 140 that is used to extract the liquid coolant from the filter chamber assembly 122, contain the extracted liquid coolant throughout the duration of the filter chamber service operation, and reinject the extracted liquid coolant back into the filter chamber assembly 122 following completion of the filter chamber service operation.

An example of the fluid containment apparatus 140 is shown in View B of FIG. 1, along with a magnified view of the drain valve 136 on the channel 112. The fluid containment apparatus 140 includes a syringe 142 that is adapted to couple with the drain valve 136 via a receptacle 144. When the drain valve 136 is in a “valve closed” configuration, the drain valve 136 forms a dripless seal, meaning that the liquid coolant does not drip or escape through the drain valve 136. However, once the drain valve 136 is mated with the receptacle 144, the drain valve 136 automatically opens to permit the flow of liquid through the receptacle 144 and into a vial of the syringe 142. The drain valve 136 may have different characteristics in different implementations. In one implementation, the drain valve 136 includes a plug component that is designed to mate with a receptacle on the fluid containment apparatus 140 to transition the plug from the closed configuration to an open configuration.

In one implementation, the vial of the syringe 142 has a volume that is equal to or larger than the liquid-storing volume that contains the coolant within the filter chamber assembly 122. By coupling the receptacle 144 to the drain valve 136 and actuating a plunger of the syringe 142 away from the vial, a service technician controllably draws the coolant that is within the filter chamber assembly 122 up into the vial of the syringe 142. Following completion of the filter chamber service operation, the service technician actuates (compresses) the plunger of the syringe 142 back toward the vial to force the extracted coolant back in the opposite direction through the receptacle 144 and back into the filter chamber assembly. This ensures no coolant is spilled or lost during the filter chamber service operation.

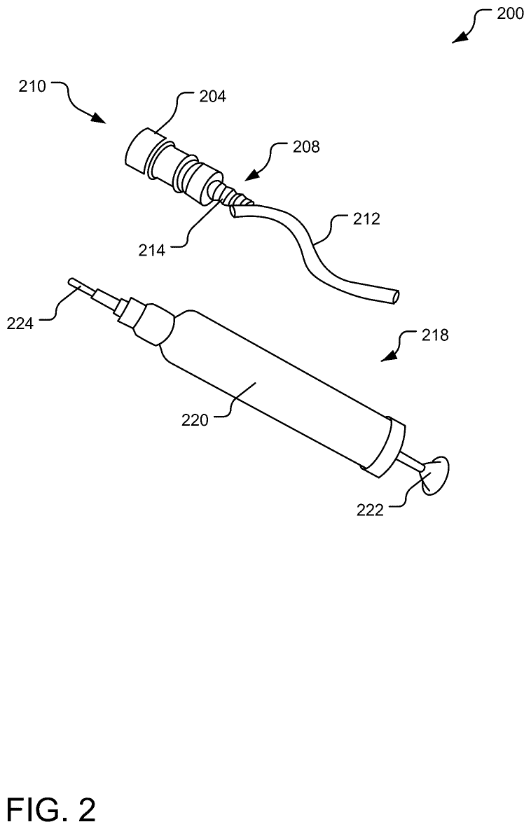

FIG. 2 illustrates components of an example filter chamber service kit 200 that is used to drain coolant from an HRU filter chamber assembly during a filter chamber access operation. The filter chamber service kit 200 includes a first drain valve component 204, tubing 212, and a syringe 218 that assemble together to form a fluid containment apparatus, also referred to herein as a syringe assembly, the same or similar to that described above with respect to FIG. 1. The first drain valve component 204 includes a first end 210 configured to mate with a second drain valve component (not shown in FIG. 2) that is formed in the housing of an HRU filter chamber, such as in the general position shown and described with respect to the drain valve 136 in View B of FIG. 1. When the second drain valve component is mated with the first end 210 of the first drain valve component 204, a seal is opened within the second drain valve component to permit the flow of coolant out of a coolant-containing cavity of the filter chamber assembly.

In one implementation, the first drain valve component 204 and the second drain valve component (not shown) are the plug and receptacle portions of a universal quick disconnect (UQD) valve. For example, the first drain valve component 204 is the receptacle portion of the UQD valve (also referred to herein as a drain valve receptacle), and the second drain valve component is the plug portion of the UQD valve (also referred to herein as a drain valve plug) configured to mate with the drain valve receptacle.

In other implementations, the first drain valve component 204 and the second drain valve component in the HRU housing form another type of dripless seal that is opened when the two components mate together.

The first drain valve component 204 includes a second end 208 opposite the first end 210, which includes a hose barb 214. The hose barb 214 includes a nozzle with an exterior surface that includes ridges or bumps that grip the inside of tubing 212 (a hose) to create a seal. The hose barb 214 has a cross-sectional diameter that matches, or that is just slightly smaller than (e.g., within 1 mm of) an internal diameter of the tubing 212. Consequently, a liquid-tight seal can be created by push-fitting the hose barb 214 into the end of the tubing 212.

In addition to the components described above, the filter chamber service kit 200 includes a syringe 218 that includes a vial 220 and a plunger 222. The vial 220 has an internal volume that is at least as large as the maximum volume of liquid coolant housed within the HRU filter chamber during nominal cooling system operations. The syringe 218 includes a needle 224 that couples to the free end of the tubing 212 (e.g., the end that is not coupled to the first drain valve component 204). In one implementation, the needle has an external diameter sized to match or that is just slightly smaller than (e.g., within 1 mm of) the internal diameter of the tubing 212 such that the needle 224 can be threaded into the tubing 212 to form a liquid-tight seal.

When a first end of the tubing 212 is coupled to the hose barb 214 of the first drain valve component 204 and a second opposite end of the tubing 212 is coupled to the needle 224 of the syringe 218, the tubing 212 creates a liquid channel for transporting coolant received at the first drain valve component 204 into the vial 220 of the syringe 218. The plunger 222 of the syringe 218 can be forced pulled away from (out of) the vial 220 to forcibly draw a liquid received at the first drain valve component 204 into the tubing 212 and, ultimately, the vial 220, which serves as a temporary containment vessel. When the plunger 222 is subsequently forced in the opposite direction (e.g., compressed into the vial 220), any liquid contained within the vial 220 is expelled from the needle 224 to traverse the entry path in the opposite direction through the tubing 212 and out through the first drain valve component 204.

In one implementation, the filter chamber service kit 200 additionally includes an HRU replacement filter. The filter chamber service kit 200 is, for example, a packaged ensemble that a technician acquires and opens when tasked with changing the filter within the HRU filter chamber assembly. In one implementation, the filter chamber service kit 200 is a single-use disposable kit. In other implementations, the components shown in FIG. 2 are designed to be reused in support of multiple filter chamber service operations. Prior to use, the components shown in FIG. 2 are assembled as described above to form a liquid containment apparatus, either by a data center technician or a manufacturer, prior to shipping the filter chamber service kit 200 to a data center.

Following the above-described assembly of the liquid containment apparatus, a service technician attaches the first drain valve component 204 to the above-described second drain valve component that is formed in the housing of an HRU filter chamber assembly, extracts liquid coolant from the filter chamber by forcing the plunger 222 outward away from the vial 220. Once the coolant is removed from the HRU filter chamber assembly in this way, the service technician can remove a cover from the HRU filter chamber assembly and service component(s) within the assembly, such as by replacing an old filter with a new filter included in the filter chamber service kit 200. After servicing the components within the filter chamber assembly, the service technician replaces the cover and forcibly compresses the plunger on the syringe 218 into the vial 220 to expel the coolant and return it to the cavity of the HRU filter chamber assembly.

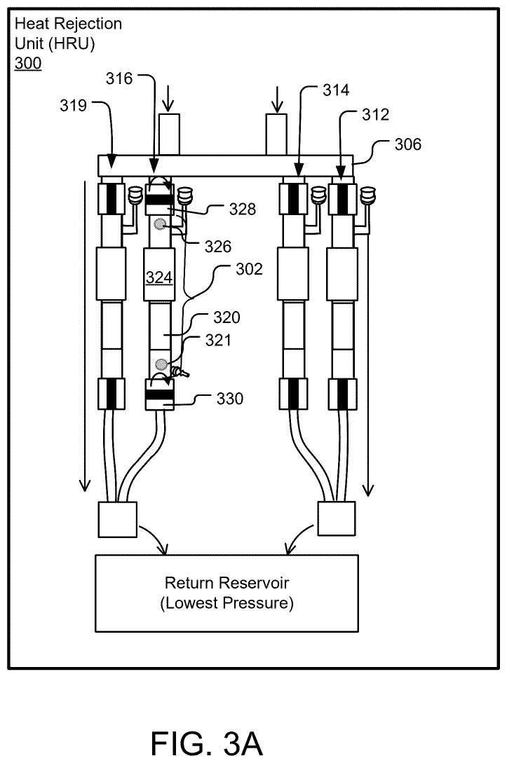

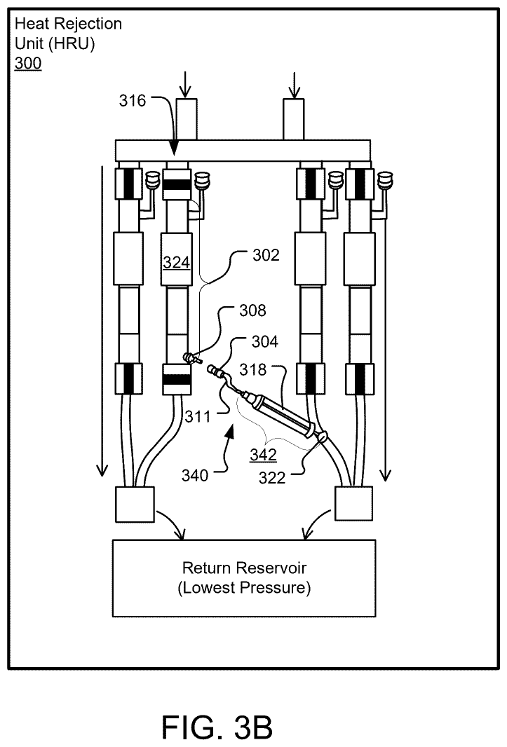

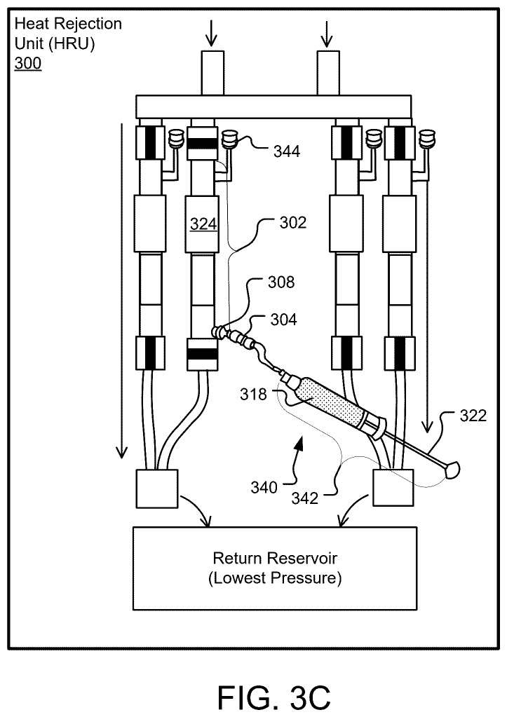

FIG. 3A-3C illustrate operations of an example filter chamber service operation utilizing the herein disclosed filter chamber service kit.

FIG. 3A illustrates steps performed during a filter chamber service operation using the disclosed technology. The filter chamber service operation is performed on a liquid-to-air HRU (HRU 300) that is, in one implementation, integrated within a liquid cooling system at a data center. The HRU 300 is in-line with a coolant loop (not shown) that circulates liquid coolant to one or more IT racks. The HRU 300 is shown to include a manifold 306, channels 312, 314, 316, and 319, and channel components substantially similar to those described with respect to FIG. 1. However, in other implementations, the manifold 306 may include different characteristics, and there may exist fewer or greater than four coolant channels internal to the HRU 300.

In implementations where the HRU 300 includes a single channel and filter chamber assembly, the entire HRU 300 may be isolated from the coolant loop prior to carrying out any of the below-described steps of the filter chamber service operation. For example, all inlet valve(s) (not shown) that provide coolant to the manifold 306 are closed along with all outlet valve(s) (not shown) that release the chilled coolant back from the HRU 300 back to the coolant loop. In the implementation shown where the HRU 300 includes four channels (e.g., channels 312, 314, 316, and 319), the HRU 300 may remain at least partially operational during the filter chamber service operation. In the service operation exemplified via steps below described with respect to FIG. 3A-3C, a component is serviced within a filter chamber assembly 302 of the channel 316.

At a time just preceding the first step of FIG. 3A, a data center technician receives a filter chamber service notification triggered by a detected condition indicative of a potential malfunction of a component that is housed within a filter chamber assembly 302 of the HRU 300. For example, the service technician receives an alert indicating that a filter 324 needs to be changed (e.g., determined based upon sensed drops in pressure or flow), that a flow meter 320 is malfunctioning, or that there is a problem with one or both pressure sensors 321, 326.

During the first step of this service operation that is illustrated in FIG. 3A, the service technician closes isolation valves 328 and 330, which are in line with the filter chamber assembly 302. Closing the isolation valve 328 isolates the filter chamber assembly 302 from an upstream portion of the coolant loop and closing the isolation valve 330 isolates the filter chamber assembly 302 from a downstream portion of the coolant loop. At this point in time, coolant is trapped within a cavity (e.g., a filter chamber) of the filter chamber assembly 302. For example, the filter 324, the flow meter 320, and the pressure sensors 321, 326 may be fully immersed in the liquid coolant that is trapped within the filter chamber assembly 302.

FIG. 3B illustrates additional steps performed during the filter chamber service operation described with respect to FIG. 3A. Subsequent to closing the isolation valves 328 and 330, the service technician acquires a liquid containment apparatus 340 (syringe assembly), which is pre-assembled by either a manufacturer or the data technician, such as by assembling together the components shown and described with respect to FIG. 2.

In one implementation, the liquid containment apparatus 340 includes features the same or similar to those described with respect to the liquid containment apparatus shown in FIG. 2. Specifically, the liquid containment apparatus 340 includes a

first drain valve component, referred to in the description of FIGS. 3A-3C as a drain valve receptacle 304. The drain valve receptacle 304 is fluidly coupled to the vial of a syringe 342 via tubing 311. The drain valve receptacle 304 is adapted to couple with a second drain valve component, referred to in FIGS. 3A-3C as a drain valve plug 308. The drain valve plug 308 is formed within the housing of the filter chamber assembly 302 and contains a dripless valve that, when opened, provides a channel into the coolant-containing cavity (filter chamber) of the filter chamber assembly 302. When the drain valve plug 308 is decoupled from the drain valve receptacle 304, the dripless valve remains in the closed position.

In one implementation, the drain valve plug 308 is the plug portion of a UQD valve, and the drain valve receptacle 304 is the receptacle portion of the UQD valve. Together, the plug portion and receptacle portion form the entirety of the UQD valve.

In the step illustrated in FIG. 3B, the service technician mates the drain valve receptacle 304 on the liquid containment apparatus 340 with drain valve plug 308 that is positioned within the housing sidewall of the filter chamber assembly 302. In various implementations, this mating can be achieved in different ways. In the implementation where the drain valve plug 308 and drain valve receptacle 304 are components of a UQD valve, the service technician applies manual pressure or uses a tool to push-fit the drain valve plug 308 and the drain valve receptacle 304 into a mated configuration that forms a liquid-tight seal (preventing drips). The creation of this seal between the plug and receptacle portions of the UQD valve also forcibly opens the valve within the drain valve plug 308 to allow liquid to flow between the drain valve plug 308 and the drain valve receptacle 304.

FIG. 3C illustrates still additional steps performed during the filter chamber service operation described with respect to 3A and 3B. After the drain valve receptacle 304 of the liquid containment apparatus 340 has been mated with the drain valve plug 308 in the filter chamber assembly of the HRU 300 as described above, the service technician actuates a plunger 322 on the liquid containment apparatus 340 in a direction away from the vial 318 to forcibly draw the liquid coolant that resides within the filter chamber assembly 302 into the vial 318 of the syringe 340, as is generally shown in FIG. 3C.

As coolant is drawn out of the filter chamber assembly 302 and into the syringe, the coolant is replaced with air drawn into the filter chamber through bleeding air valve 344.

While the filter chamber fluid is contained within the vial 318, the service technician may elect to either remove the liquid containment apparatus 340 from the HRU 300 or leave it attached (e.g., dangling free) while mated to the drain valve plug 308. Removing the liquid containment apparatus 340 from the HRU 300 entails decoupling the drain valve plug 308 from the drain valve receptacle 304. In an implementation where this mating is achieved by push-fit, the decoupling can be achieved by forcibly pulling the drain valve receptacle 304 away from the drain valve plug 308. In implementations where the connection between the HRU 300 and the liquid containment apparatus 340 is forged by other types of valve components, coupling and decoupling may be achieved by other operations readily understood and used in the art (e.g., twisting, threading).

Decoupling the drain valve plug 308 from the drain valve receptacle 304 forcibly closes the valve within the drain valve plug 308, trapping the liquid coolant in the vial 318 even after the liquid containment apparatus 340 is decoupled from the HRU 300. Decoupling the liquid containment apparatus 340 from the HRU 300 prior to performing the filter chamber service operation may favorably provide the service technician with more physical space to move about (e.g., to move and position their arms) while performing the filter chamber service operation. However, the liquid containment apparatus 340 can likewise remain attached to the HRU 300 throughout the service operation.

While the coolant from the filter chamber assembly 302 is contained within the vial 318 of the syringe 342, the service technician removes a cover (not shown) from the outer housing of the filter chamber assembly 302 to acquire access to the interior cavity of the filter chamber, which is no longer submerged in coolant since the coolant has been drawn up into the syringe 342. The service technician then repairs or replaces one or more components within the cavity, such as by replacing the filter 324 or repairing or replacing a sensor (not shown). Following the repair or replacement operation, the service technician re-affixes the cover on the filter chamber assembly 302 and subsequently reinjects the coolant contained within the syringe 342 into the cavity of filter chamber assembly 302 through the drain valve receptacle 304. If the liquid containment apparatus 340 was unmated from the drain valve receptacle 304 during the previous filter chamber component repair/replacement operation, the service technician recouples the drain valve plug 308 to the drain valve receptacle 304 prior to reinjecting the coolant.

As coolant is reinjected into the filter chamber assembly 302, the coolant replaces the air that is expelled through the bleeding air valve 344.

Reinjecting the coolant is then achieved by actuating the plunger 322 toward and into the vial 318 of the syringe 342 while the drain valve receptacle 304 is coupled to the drain valve plug 308 as shown. This action allows all of the captured coolant to be reused within the cooling system, preventing fluid loss that may otherwise eventually lead to system malfunction if not replenished upon reaching critically low levels.

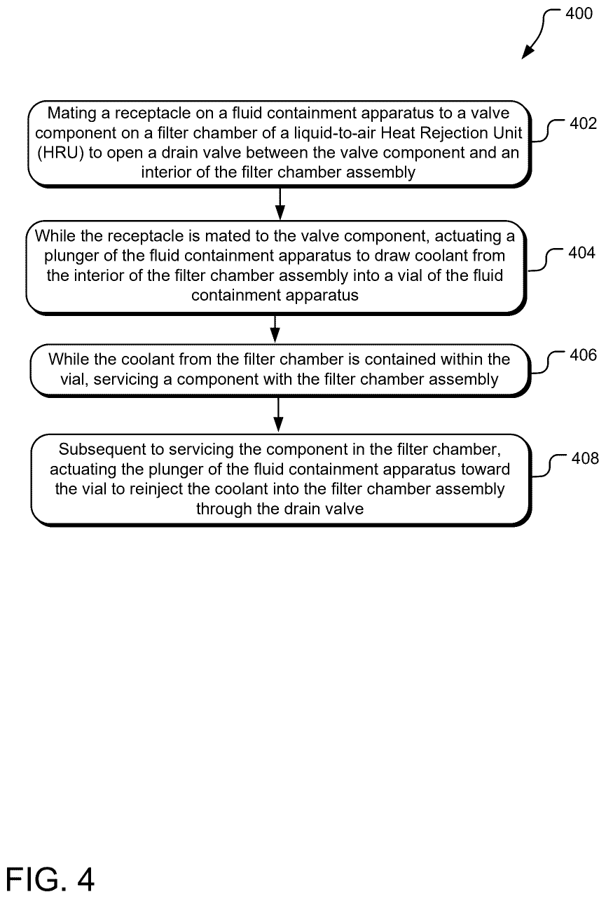

FIG. 4 illustrates example operations 400 for servicing a component within a filter chamber assembly of a liquid-to-air HRU. Servicing the component entails draining coolant from the filter chamber cavity using a service kit that incorporates aspects of the herein-disclosed technology. The filter chamber assembly includes a housing with a valve component accessible from the exterior of the HRU. A mating operation 402 mates a receptacle on a fluid containment apparatus (e.g., a syringe assembly) to the valve component on the filter chamber assembly. This action opens a drain valve between the valve component and the filter chamber. The seal is a dripless seal that is open exclusively when the valve component is mated with the receptacle on the fluid containment apparatus. In one implementation, the valve component includes the plug portion of a UQD valve, and the receptacle includes the receptacle portion of a UQD valve.

A fluid extraction operation 404 provides for extracting coolant from the filter chamber into a vial of the fluid containment apparatus by actuating a plunger of the fluid containment apparatus away from the vial while the receptacle is mated to the valve component.

A servicing operation 406 provides for servicing the component with the filter chamber assembly while the coolant from the filter chamber is contained within the vial. For example, the servicing operation 406 entails removing a cover on the filter chamber assembly to acquire access to the component and then repairing or replacing the component. In one implementation, the servicing operation 406 entails replacing an HRU filter used to filter liquid coolant flowing through the cooling system. In another implementation, the servicing operation 406 entails repairing or replacing a flow meter, pressure sensor, or other component that resides at least partially within the drained cavity of the filter chamber assembly.

A fluid replacement operation 408 is performed subsequent to completing the servicing operation 408 by actuating the plunger of the fluid containment apparatus toward the vial to reinject the coolant into the filter chamber assembly through the receptacle. The fluid replacement operation 408 is performed while the receptacle of the fluid containment apparatus is coupled to the drain valve component on the filter chamber housing.

In some aspects, the techniques described herein relate to a method for servicing a component within a filter chamber assembly of a liquid-to-air Heat Rejection Unit (HRU), the method including: mating a receptacle on a fluid containment apparatus to a drain valve component on the filter chamber assembly to open a seal between the drain valve component and an interior of the filter chamber assembly; while the receptacle is mated to the drain valve component actuating a plunger of the fluid containment apparatus to draw coolant from the interior of the filter chamber assembly into a vial of the fluid containment apparatus; while the coolant from the filter chamber assembly is contained within the vial, servicing the component with the filter chamber assembly; and subsequent to servicing the component, actuating the plunger of the fluid containment apparatus toward the vial to reinject the coolant into the interior of the filter chamber assembly through the receptacle.

In some aspects, the techniques described herein relate to a method, further including: prior to actuating the plunger, closing one or more isolation valves in-line with the filter chamber assembly to isolate the interior of the filter chamber assembly of the liquid-to-air HRU from a remainder of a coolant loop that flows the coolant through the liquid-to-air HRU.

In some aspects, the techniques described herein relate to a method, wherein the drain valve component is a plug portion of a universal quick disconnect (UQD) valve and the receptacle on the fluid containment apparatus is a receptacle portion of the UQD valve.

In some aspects, the techniques described herein relate to a method, wherein the fluid containment apparatus includes the receptacle, tubing, and a syringe including the plunger and the vial, and wherein the receptacle is coupled to the vial of the syringe via the tubing.

In some aspects, the techniques described herein relate to a method, wherein the filter chamber assembly includes a cavity that houses a filter.

In some aspects, the techniques described herein relate to a method, wherein servicing the component further includes: removing a cover from the filter chamber assembly; and servicing a component within the filter chamber assembly; and replacing the cover on the filter chamber assembly.

In some aspects, the techniques described herein relate to a method, wherein servicing the component includes: replacing a filter.

In some aspects, the techniques described herein relate to a method, wherein servicing the component includes replacing a flow meter.

In some aspects, the techniques described herein relate to a method, wherein the filter chamber assembly includes a bleeding air valve that draws air into the interior of the filter chamber assembly as the plunger of the fluid containment apparatus is actuated to draw the coolant into the vial.

In some aspects, the techniques described herein relate to a method, further including: subsequent to actuating the plunger of the fluid containment apparatus to reinject the coolant into the interior of the filter chamber assembly, decoupling the receptacle of the fluid containment apparatus from the drain valve component.

In some aspects, the techniques described herein relate to a method, wherein decoupling the receptacle from the drain valve component creates a dripless seal to contain liquid in the vial of the fluid containment apparatus.

In some aspects, the techniques described herein relate to a system including: a liquid-to-air heat rejection unit (HRU) that receives and circulates a liquid coolant during nominal operations, the liquid-to-air HRU including a filter chamber assembly that includes a drain valve plug for releasing fluid from an interior of the filter chamber assembly; and a fluid containment apparatus including: a drain valve receptacle with a first end configured to mate with the drain valve plug; a syringe including a vial and a plunger; and tubing that fluidly couples the drain valve receptacle to a vial of a syringe such that actuating the plunger of the syringe away from the vial while the drain valve receptacle is mated with the drain valve plug on the filter chamber assembly draws the liquid coolant from the interior of the filter chamber assembly into the vial.

In some aspects, the techniques described herein relate to a system, wherein mating the drain valve receptacle and the drain valve plug opens a seal between the drain valve plug and the interior of the filter chamber assembly.

In some aspects, the techniques described herein relate to a system, wherein the filter chamber assembly includes a filter chamber cover that can be removed from the filter chamber assembly without spilling the liquid coolant while the liquid coolant is contained within the vial.

In some aspects, the techniques described herein relate to a system, wherein the filter chamber assembly houses a filter and a flowmeter.

In some aspects, the techniques described herein relate to a system, wherein the drain valve plug is a plug portion of a universal quick disconnect (UQD) valve and the drain valve receptacle is a receptacle portion of the UQD valve, the receptacle portion configured to mate with the plug portion to open a seal formed by the plug portion.

In some aspects, the techniques described herein relate to a system, wherein the filter chamber assembly is coupled to a bleeding air valve that draws air into the interior of the filter chamber assembly as the syringe is actuated to draw the liquid coolant into the vial of the syringe.

In some aspects, the techniques described herein relate to a system, wherein the liquid coolant is sealed within the vial of the syringe by decoupling the drain valve receptacle from the drain valve plug on the filter chamber assembly.

In some aspects, the techniques described herein relate to a method for changing a component within a filter chamber assembly of a liquid-to-air Heat Rejection Unit (HRU), the method including: closing an isolation valve in-line with the filter chamber assembly to isolate a filter chamber of the liquid-to-air HRU from an upstream portion of a coolant loop that circulates a liquid coolant; subsequent to closing the isolation valve, creating a liquid-tight coupling between a fluid containment apparatus and the filter chamber of the liquid-to-air HRU by attaching a first drain valve component on the fluid containment apparatus to a second drain valve component on the filter chamber, the fluid containment apparatus including a syringe attached to the second drain valve component via tubing; while the first drain valve component is coupled to the second drain valve component, actuating a plunger of the fluid containment apparatus to drain the filter chamber by drawing the liquid coolant from the filter chamber into a vial of the fluid containment apparatus; while the liquid coolant from the filter chamber is contained in the vial, servicing a component with the filter chamber assembly; and subsequent to servicing the component, actuating the plunger of the fluid containment apparatus toward the vial to reinject the liquid coolant into the filter chamber assembly.

In some aspects, the techniques described herein relate to a method, wherein the first drain valve component and the second drain valve component are different portions of a universal quick disconnect (UQD) valve and wherein coupling the first drain valve component to the second drain valve component opens a first seal between the first drain valve component and the filter chamber and a second seal between the second drain valve component and the vial of the syringe.

The logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of exemplary implementations.

What is claimed is:

1. A method for servicing a component within a filter chamber assembly of a liquid-to-air Heat Rejection Unit (HRU), the method comprising:
mating a receptacle on a fluid containment apparatus to a valve component on the filter chamber assembly to open a drain valve between the valve component and an interior of the filter chamber assembly;
while the receptacle is mated to the valve component actuating a plunger of the fluid containment apparatus to draw coolant from the interior of the filter chamber assembly into a vial of the fluid containment apparatus;
while the coolant from the filter chamber assembly is contained within the vial, servicing the component within the filter chamber assembly; and
subsequent to servicing the component, actuating the plunger of the fluid containment apparatus toward the vial to reinject the coolant into the interior of the filter chamber assembly through the drain valve.

2. The method of claim 1, further comprising:
prior to actuating the plunger, closing one or more isolation valves in-line with the filter chamber assembly to isolate the interior of the filter chamber assembly of the liquid-to-air HRU from a remainder of a coolant loop that flows the coolant through the liquid-to-air HRU.

3. The method of claim 1, wherein the valve component is a plug portion of a universal quick disconnect (UQD) valve and the receptacle on the fluid containment apparatus is a receptacle portion of the UQD valve.

4. The method of claim 1, wherein the fluid containment apparatus includes the receptacle, tubing, and a syringe including the plunger and the vial, and wherein the receptacle is coupled to the vial of the syringe via the tubing.

5. The method of claim 1, wherein the filter chamber assembly includes a cavity that houses a filter.

6. The method of claim 1, wherein servicing the component further comprises:
removing a cover from the filter chamber assembly; and
servicing a component within the filter chamber assembly; and
replacing the cover on the filter chamber assembly.

7. The method of claim 6, wherein servicing the component includes:
replacing a filter.

8. The method of claim 6, wherein servicing the component includes replacing a flow meter.

9. The method of claim 1, wherein the filter chamber assembly includes a bleeding air valve that draws air into the interior of the filter chamber assembly as the plunger of the fluid containment apparatus is actuated to draw the coolant into the vial.

10. The method of claim 1, further comprising:
subsequent to actuating the plunger of the fluid containment apparatus to reinject the coolant into the interior of the filter chamber assembly, decoupling the receptacle of the fluid containment apparatus from the valve component.

11. The method of claim 1, wherein decoupling the receptacle from the valve component creates a dripless seal to contain liquid in the vial of the fluid containment apparatus.

12. A system comprising:
a liquid-to-air heat rejection unit (HRU) that receives and circulates a liquid coolant during nominal operations, the liquid-to-air HRU including a filter chamber assembly that includes a drain valve plug for releasing fluid from an interior of the filter chamber assembly; and
a fluid containment apparatus comprising:
a drain valve receptacle with a first end configured to mate with the drain valve plug;
a syringe including a vial and a plunger; and
tubing that fluidly couples the drain valve receptacle to a vial of a syringe such that actuating the plunger of the syringe away from the vial while the drain valve receptacle is mated with the drain valve plug on the filter chamber assembly draws the liquid coolant from the interior of the filter chamber assembly into the vial.

13. The system of claim 12, wherein mating the drain valve receptacle and the drain valve plug opens a seal between the drain valve plug and the interior of the filter chamber assembly.

14. The system of claim 12, wherein the filter chamber assembly includes a filter chamber cover that can be removed from the filter chamber assembly without spilling the liquid coolant while the liquid coolant is contained within the vial.

15. The system of claim 12, wherein the filter chamber assembly houses a filter and a flowmeter.

16. The system of claim 12, wherein the drain valve plug is a plug portion of a universal quick disconnect (UQD) valve and the drain valve receptacle is a receptacle portion of the UQD valve, the receptacle portion configured to mate with the plug portion to open a seal formed by the plug portion.

17. The system of claim 12, wherein the filter chamber assembly is coupled to a bleeding air valve that draws air into the interior of the filter chamber assembly as the syringe is actuated to draw the liquid coolant into the vial of the syringe.

18. The system of claim 12, wherein the liquid coolant is sealed within the vial of the syringe by decoupling the drain valve receptacle from the drain valve plug on the filter chamber assembly.

19. A method for changing a component within a filter chamber assembly of a liquid-to-air Heat Rejection Unit (HRU), the method comprising:
closing an isolation valve in-line within the filter chamber assembly to isolate a filter chamber of the liquid-to-air HRU from an upstream portion of a coolant loop that circulates a liquid coolant;
subsequent to closing the isolation valve, creating a liquid-tight coupling between a fluid containment apparatus and the filter chamber of the liquid-to-air HRU by attaching a first drain valve component on the fluid containment apparatus to a second drain valve component on the filter chamber, the fluid containment apparatus including a syringe attached to the second drain valve component via tubing;
while the first drain valve component is coupled to the second drain valve component, actuating a plunger of the fluid containment apparatus to drain the filter chamber by drawing the liquid coolant from the filter chamber into a vial of the fluid containment apparatus;
while the liquid coolant from the filter chamber is contained in the vial, servicing a component within the filter chamber assembly; and
subsequent to servicing the component, actuating the plunger of the fluid containment apparatus toward the vial to reinject the liquid coolant into the filter chamber assembly.

20. The method of claim 19, wherein the first drain valve component and the second drain valve component are different portions of a universal quick disconnect (UQD) valve and wherein coupling the first drain valve component to the second drain valve component opens a first seal between the first drain valve component and the filter chamber and a second seal between the second drain valve component and the vial of the syringe.
